(19) United States
(12) Patent Application Publication
(10) Pub. No.: US 2017/0026186 A1
(43) Pub. Date: Jan. 26, 2017

(54) DETECTION OF FRAUDULENT DIGITAL CERTIFICATES

(71) Applicant: Fortinet, Inc., Sunnyvale, CA (US)

(72) Inventor: Xin Gu, Delta (CA)

(73) Assignee: Fortinet, Inc., Sunnyvale, CA (US)

(21) Appl. No.: 14/809,245

(22) Filed: Jul. 26, 2015

(51) Int. Cl. H04L 9/32; H04L 29/06

(52) U.S. Cl. CPC H04L 9/3268; H04L 9/3265; H04L 63/0823; H04L 63/123; H04L 63/02

(57) ABSTRACT

Systems and methods for verifying a digital certificate are provided. According to one embodiment, a network security device intercepts a session between a client and a server, wherein a secure channel is requested to be established between the client and the server in the session. The network security device captures a digital certificate that is being sent from the server to the client, wherein the digital certificate is used for authenticating the server in connection with establishing the secure channel. The network security device verifies the authenticity of the server certificate and performs an action with respect to the session based on a result of the verifying.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015, Fortinet, Inc.

### BACKGROUND

Field

Embodiments of the present invention generally relate to computer networking. In particular, various embodiments relate to detection of fraudulent digital certificates, e.g., web server certificates.

Description of the Related Art

Many networking applications require secure and authenticated communications. Secure Sockets Layer (SSL) and its related protocols are often used to enable secure communications between a client and a server. According to SSL protocols, session information between an SSL client and an SSL server are negotiated through a handshake phase and the identity of the SSL server is verified by the SSL client. The session information may include a session ID, peer certificates, the cipher specification to be used, the compression algorithm to be used, and shared secrets that are used to generate symmetric cryptographic keys. The SSL client encrypts a premaster secret with a public key from the SSL server's certificate and transmits the premaster secret to the server. Then, both parties compute the master secret locally and derive the session key from it. After the handshake phase, a secure socket is established, and application data encrypted by the session key can be securely transmitted between the client and server.

During the handshake phase, the SSL server sends a server certificate that is issued by a certificate authority (CA) and signed with a CA certificate. When the server certificate is received by the SSL client, the SSL client may extract the certificate path of the server certificate and locate the CA certificate. The SSL client may search for the CA certificate in its certificate store. If the CA certificate that signed the server certificate is one of the trusted root certificates that are installed in the certificate store, the SSL client trusts and accepts the server certificate. If the CA certificate is not one of the trusted root certificates, the SSL client may reject the server certificate and present a warning message to the user. The user is warned that the security certificate is not issued by a trusted CA and is provided with options to continue or stop establishing the secure connection. If the user decides to continue the secure connection even though the CA is not trusted by the SSL client, the SSL client may temporally accept this CA certificate. Generally, it is not a good practice for the user to accept un-trusted certificates when a warning message is presented.

The SSL session between the SSL client and the SSL server is vulnerable to a man-in-the-middle attack. For example, a third party may intercept the SSL session and replace the server certificate with a fraudulent server certificate that is usually issued by the third party. When the fraudulent server certificate is received, the SSL client checks the CA of the fraudulent server certificate, i.e., the third party, in its certificate store. Usually, the third party is not among the trusted root certificates of the SSL client and a warning message is displayed to the user of the SSL client. However, some users who do not understand that an attacker may be eavesdropping on and/or altering communications with the server may ignore the warning message and allow the fraudulent server certificate. It is also possible that the third party has already installed its CA certificate on the SSL client, thereby making the third party a trusted issuer for the SSL client. In this scenario, no warning message is displayed to the user of the SSL client when the fraudulent server certificate is received.

Therefore, there is a need for a mechanism for detecting fraudulent server certificates for client appliances.

### SUMMARY

Systems and methods are described for verifying a digital certificate. According to one embodiment, a network security device intercepts a session between a client and a server, wherein a secure channel is requested to be established between the client and the server in the session. The network security device captures a digital certificate that is sent from the server to the client, wherein the digital certificate is used for authenticating the server in establishing the secure channel. The network security device verifies if the captured digital certificate is an authentic certificate of the server and performing an action to the session between the client and server based on a result of the verifying.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an exemplary network architecture in accordance with an embodiment of the present invention.

FIG. 2 illustrates an exemplary network architecture in accordance with another embodiment of the present invention.

FIG. 3 illustrates exemplary functional units of a network security device in accordance with a first embodiment of the present invention.

FIG. 4 illustrates exemplary functional units of a network security device in accordance with a second embodiment of the present invention.

FIG. 5 illustrates exemplary functional units of a network security device in accordance with a third embodiment of the present invention.

FIG. 6 is a flow diagram illustrating a method for checking a server certificate in a session between a client and a server in accordance with an embodiment of the present invention.

FIG. 7 is a flow diagram illustrating a method for collecting and verifying server certificates in accordance with an embodiment of the present invention.

FIG. 8 is an exemplary computer system in which or with which embodiments of the present invention may be utilized.

### DETAILED DESCRIPTION

Systems and methods are described for verifying a digital certificate. According to one embodiment, a network security device intercepts a session between a client and a server, wherein a secure channel is requested to be established between the client and the server in the session. The network security device captures a digital certificate that is sent from the server to the client, wherein the digital certificate is used for authenticating the server in establishing the secure channel. The network security device verifies if the captured digital certificate is an authentic certificate of the server and performing an action to the session between the client and server based on a result of the verifying.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The phase “network security device” generally refers to a hardware or software device or appliance configured to be coupled to a network and to provide one or more of data privacy, protection, encryption and security. The network security device can be a device providing one or more of the following features: network firewalling, VPN, antivirus, intrusion prevention (IPS), content filtering, data leak prevention, antispam, antispyware, logging, reputation-based protections, event correlation, network access control, vulnerability management. Load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

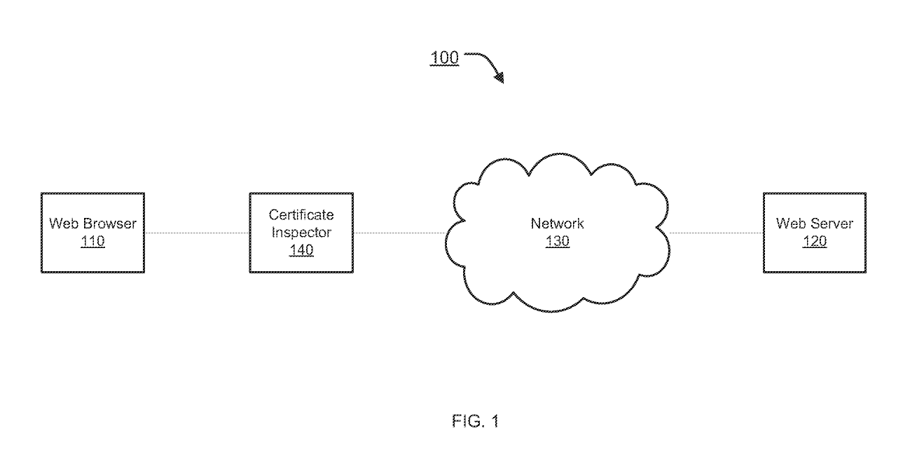

FIG. 1 illustrates an exemplary network architecture 100 in accordance with an embodiment of the present invention. Network architecture 100 includes at least one client, such as web browser 110, at least one server, such as web server 120, a network 130 and a certificate inspector 140. In the present example, web browser 110 initiates a session to establish a secure channel with web server 120 through network 130, which may be any type of network, such as a local area network (LAN), a wireless LAN, a wide area network (WAN), or the Internet. The secure channel is a network connection in which data is encrypted when transmitted between the client and server to protect the data from being intercepted by a third party. Depending upon the particular implementation, the encryption mechanism can be any type of encryption, including, but not limited to, Secure Sockets Layer/Transport Layer Security (SSL/TLS), and Internet Protocol security (IPsec). To establish the secure channel, a server certificate is sent from web server 120. The server certificate is signed by a CA to verify that the server is trusted and the message is actually sent from the server. Web browser 110 may check the certificate path of the server certificate to ascertain the CA certificate that signed the server certificate. If the CA certificate is in the trusted root certificate list of web browser 110, then the server certificate is deemed to be an authentic server certificate.

To protect the client, such as web browser 110 from a man-in-the-middle attack, certificate inspector 140 is deployed between web browser 110 and web server 120. In one example, certificate inspector 140 may implemented within a firewall (e.g., one of the FortiGate family of firewalls/UTM appliances manufactured by the assignee of the present invention) or other network security device that is deployed at a border of a private network to protect network appliances that connect to the private network. In another example, certificate inspector 140 may be implemented as part of an endpoint security management software application (e.g., one of the FortiClient family of endpoint protection suites manufactured by the assignee of the present invention) that is installed on client devices. Certificate inspector 140 may intercept network traffic between web browser 110 and web server 120 and control the network traffic based on security policies defined by the network administrator. According to the SSL protocol, web browser 110 sends a client hello message to web server 120 during a handshake phase. In response, web server 120 returns a server hello message with a server certificate to web browser 110. The hello messages and the server certificate are sent in plain text without encryption. Certificate inspector 140 may analyze session messages between web browser 110 and web server 120 to capture the server certificate from the server hello message sent from web server 120 to web browser 110.

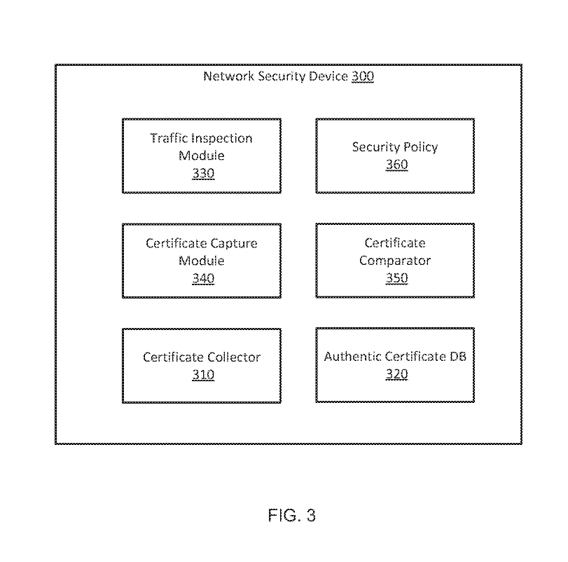

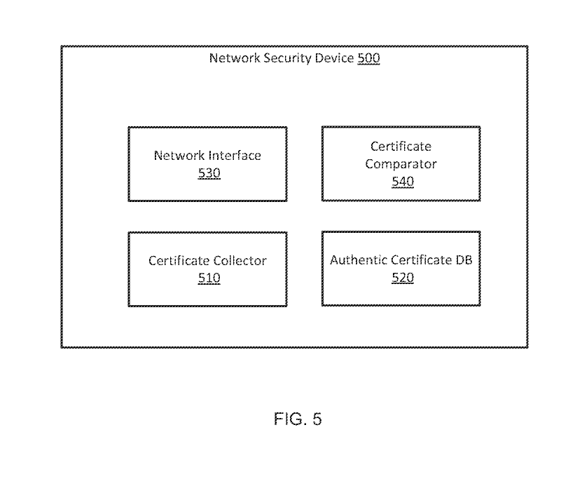

Certificate inspector 140 may also include an authentic server certificate database. For example, the authentic server certificate database, as will be described in further detail below with reference to FIGS. 3 and 5, may be a collection of authentic server certificates of well-known servers, including, but not limited to, search engines, social networks, financial institutions, email services and the like. The authentic server certificate database may be collected by certificate inspector 140 or downloaded from another network security device, e.g., one offering integrated subscription based security services, such as the FortiGuard family of integrated subscription based security services available from the assignee of the present invention or one offering hosted security services, such as the FortiCloud family of hosted security analytics, log retention and management services provided by the assignee of the present invention.

After a server certificate is captured, certificate inspector 140 may compare the captured server certificate with the authentic server certificates stored in the database to verify the authenticity of the captured server certificate. Certificate inspector 140 may extract certificate paths of the captured server certificate and a corresponding authentic server certificates. A certificate path may include a root CA certificate, as well as intermediate certificates, if any. Certificate inspector 140 may compare the certificate path of the captured server certificate and the certificate path of the authentic server certificate. If they are the same, then the captured server certificate may be verified as a true or authentic server certificate. If the root certificate or any of the intermediate certificates of the captured server certificate is different from that of the authentic server certificate, the captured server certificate is deemed to be a fraudulent or a suspicious server certificate. For example, the authentic server certificate of website www.fortinet.com is signed by an intermediate certificate DigiCert High Assurance CA-3. The intermediate certificate is signed by a root CA certificate DigiCert. When certificate inspector 140 captures a server certificate of the website www.fortinet.com that is signed by a root CA, such as “Hacker CA”, the captured server certificate is tagged as a fraudulent server certificate. In another example, certificate inspector 140 may also extract other certificate information of from the captured server certificate and the authentic server certificate, including, but not limited to, a version, a serial number, a signature algorithm, a signature hash algorithm, a valid date, a subject and the like. This additional certificate information of the captured server certificate may also be verified. If any certificate information of the captured server certificate is different from that of the authentic server certificate, the captured server certificate may be deemed to be a fraudulent or suspicious server certificate.

After the captured server certificate is verified as an authentic server certificate, the session messages between web browser 110 and web server 120 are allowed by certificate inspector 140. The secure channel may be established and data may be transmitted between web browser 110 and web server 120 through the secure channel.

If the captured server certificate is deemed to be a fraudulent server certificate, certificate inspector 140 may take one or more actions with respect to network traffic between web browser 110 and web server 120 based on a security policy of the network. For example, a warning message may be presented to the user of web browser 110 to inform the user regarding the fraudulent server certificate. As discussed in the Background, for existing client devices, if a CA certificate of a computer hacker is installed within the trusted root certificate list of a browser, fraudulent server certificates signed by the computer hacker are treated as authentic server certificates by web browser and no warning message is displayed to the user. In contrast, in the context of embodiments of the present invention, the fraudulent server certificate may be identified by certificate inspector 140 and a warning message may be displayed to the user even if the trusted root certificate list is hacked by the computer hacker. In another example, network traffic between web browser 110 and web server 120 may be blocked by certificate inspector 140 if a fraudulent server certificate is detected.

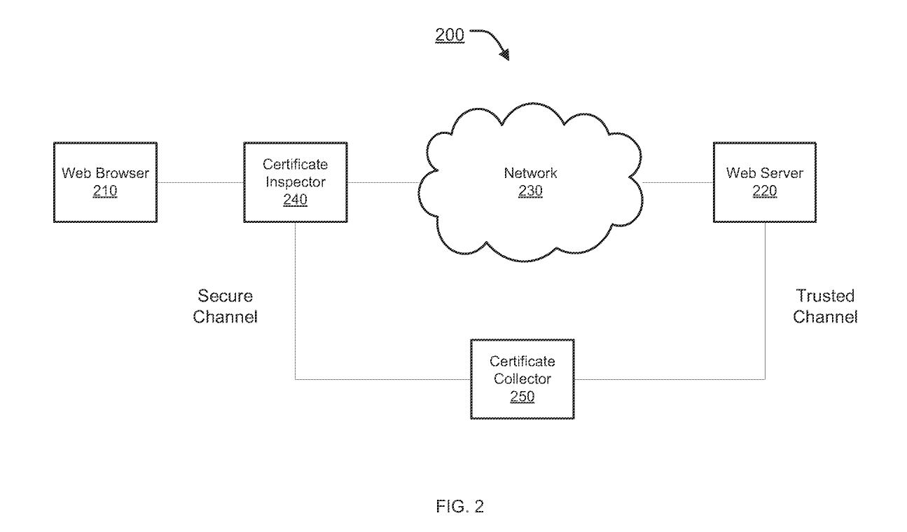

FIG. 2 illustrates an exemplary network architecture 200 in accordance with another embodiment of the present invention. Network architecture 200 includes web browser 210, a web server 220, a network 230, a certificate inspector 240 and a certificate collector 250. In the present example, web browser 210, web server 220 and network 230 operate in the same manner as discussed above in connection with FIG. 1, therefore further description thereof is omitted for the sake of brevity.

Certificate collector 250 may be a network security device (e.g., one offering integrated subscription based security services, such as the FortiGuard family of integrated subscription based security services available from the assignee of the present invention) that can be accessed by certificate inspector 240. Certificate collector 250 may collect server certificates of popular servers through trusted channels to ensure that the server certificates are authentic. In one example, multiple certificate collectors 250 may be deployed at different locations within the Internet and near Internet Service Providers' (ISPs') backbone networks. Then, certificate collector 250 may establish a secure channel with web server 220 and capture the server certificate of web server 220. As certificate collector 250 is near ISPs' backbone networks, the possibility that the secure channel with web server 220 is hacked by man-in-the-middle attack is low become there are fewer intermediate networking devices between certificate collector 250 and web server 220. Therefore, the captured server certificate by certificate collector 250 is deemed to be the authentic server certificate of web server 220. In another example, multiple firewalls may be deployed at different locations within the Internet. Each of the firewalls may capture a large number of server certificates of a web server from its network traffic with the web server. The server certificates of the web server that are captured by the firewalls may be collected by certificate collector 250. Therefore, certificate collector 250 may collect a large number of samples of server certificates of popular servers. The certificate path and other information associated with the captured server certificate samples may be analyzed by certificate collector 250. Because man-in-the-middle attacks are low probability events, the most used one of the samples of the server certificate of a web server may be deemed as the authentic server certificate of the web site. In a further example, the administrator of certificate collector 250 may contact the administrators of the popular web servers and ask for the authentic server certificates of the web servers. The authentic server certificates of the web servers may be provided by the administrators of the web servers through online or offline trusted channels. The authentic server certificates provided by the administrators of the popular servers may be imported to certificate collector 250 manually. Certificate collector 250 may maintain an authentic server certificate database that stores authentic server certificates of popular servers of the Internet and provide a certificate verification service to client devices or network security devices.

Certificate inspector 240 may intercept network traffic between web browser 210 and web server 220 and capture a server certificate that is sent from web server 220 to web browser 210. When a server certificate is captured by certificate inspector 240, the captured server certificate is sent to certificate collector 250 for inspection. In one example, a secure channel may be established between certificate inspector 240 and certificate collector 250. Then, the captured server certificate is sent to certificate collector 250 by certificate inspector 240 through the secure channel. Certificate collector 250 may compare the captured server certificate of the web server with the authentic server certificate of the web server stored in authentic server certificate database. If the certificate path of the captured server certificate is the same as the certificate path of the authentic server certificate, certificate collector 250 may verify the authenticity of the captured server certificate. If the certificate path of the captured server certificate is different from the certificate path of the authentic server certificate, certificate collector 250 may mark the captured server certificate as fraudulent or suspicious and may provide detailed information regarding which parts of the captured server certificate are different from the authentic server certificate to certificate inspector 240. If the captured server certificate is deemed to be authentic, certificate inspector 240 may allow network traffic between web browser 210 and web server 220. If the captured server certificate is deemed to be a fraudulent server certificate by certificate collector 250, certificate inspector 240 may take one or more actions with respect to network traffic between web browser 210 and web server 220 based on a security policy of the network.

FIG. 3 illustrates exemplary functional units of a network security device 300 in accordance with a first embodiment of the present invention. In this example, network security device 300 may be used as a certificate inspector (e.g., certificate inspector 140 of FIG. 1). Network security device 300 may include a certificate collector 310, an authentic certificate DB 320, a traffic inspection module 330, a certificate capture module 340, a certificate comparator 350 and a security policy 360.

Certificate collector 310 is used for collecting server certificates of popular servers through trusted channels to ensure that the server certificates are authentic. Certificate collector 310 may establish a secure channel with online servers and capture the server certificates of the servers. The server certificates captured by certificate collector 310 may be compared with server certificates that are captured by other certificate collectors that are deployed at different locations throughout the Internet. When the captured server certificates are the same as the server certificates that are captured by other certificate collectors, the server certificate captured by certificate collector 310 may be deemed to be an authentic server certificate. In another example, the authentic server certificates of the servers may be acquired via other online or offline channels and imported into certificate collector 310 manually.

Authentic server certificate DB 320 is used for storing the authentic server certificates that are collected by certificate collector 310. Authentic certificate DB 320 may be a local, remote or cloud-based database that can be accessed by network security device 300. In another example, authentic certificate DB 320 may be downloaded from other network security devices that provide certificate verification services.

Traffic inspection module 330 is used for capturing network traffic of client devices that are connected to a private network that is protected by network security device 300. Network traffic going through the network may be scanned, and then allowed, dropped or blocked based on the results of scanning.

Data packets of network traffic captured by traffic inspection module 330 may be analyzed by certificate capture module 340. Session messages between clients and servers may be detected by certificate capture module 340. When a server hello message is observed/detected, certificate capture module 340 may further capture a server certificate that is included in the hello message based on a corresponding protocol.

Certificate comparator 350 is used for comparing the captured server certificate with the authentic server certificate stored in authentic certificate DB 320 and determining whether the captured server certificate is authentic. In one example, certificate comparator 350 may compare the two server certificates or their hash values. If they are identical, the captured server certificate is deemed to be an authentic server certificate. In another example, certificate comparator 350 may extract certificate paths of the captured server certificate and the authentic server certificate, including the root CA certificates and intermediate certificates, if any, of the server certificates. Certificate comparator 350 may compare the root CA certificates and intermediate certificates of the captured server certificate and the authentic server certificate. If they are the same, then the captured server certificate may be verified as a true server certificate. If the root certificate or any of the intermediate certificates of the captured server certificate are different from that of the authentic server certificate, the captured server certificate is deemed to be a fraudulent or suspicious server certificate. In a further example, certificate comparator 350 may also extract certificate information from the captured server certificate and the authentic server certificate, including, but not limited to, a version, a serial number, a signature algorithm, a signature hash algorithm, a valid date, a subject, and the like. The certificate information of both certificates may be compared with each other. If any certificate information of the captured server certificate is different from corresponding information of the authentic server certificate, the captured server certificate may be deemed to be a suspicious or fraudulent server certificate.

After certificate comparator 350 determines whether the captured server certificate is an authentic server certificate, traffic inspection module 330 may take one or more actions on the session between the client and the server in accordance with security policy 360 that is defined by the administrator of network security device 300. For example, when the authenticity of the captured server certificate is confirmed, traffic inspection module 330 may allow the network traffic. Then, the server hello message as well as the server certificate may be routed to the client and a secure channel between the client and the server may be established based on the key exchange protocol. When, however, the captured server certificate is deemed to be a suspicious server certificate, traffic inspection module 330 may cause a warning message to be presented on the client device. The warning message may include information regarding the captured server certificate as well as the authentic server certificate. The warning message may provide the user of the client device with an option to block the session or allow the session to be continued with the suspicious server certificate. Alternatively, when the server certificate is deemed to be a fraudulent server certificate, traffic inspection module 330 may drop or block the session between the client and the server directly, without seeking input from the user of the client device.

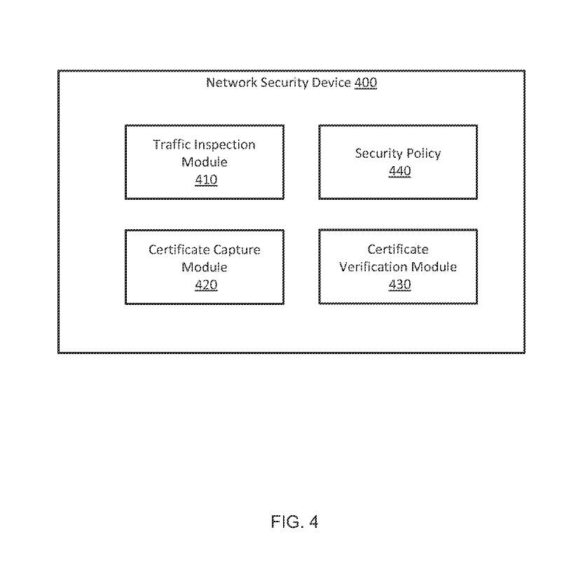

FIG. 4 illustrates exemplary functional units of a network security device 400 in accordance with a second embodiment of the present invention. In this example, network security device 400 includes a traffic inspection module 410, a certificate capture module 420, a certificate verification module 430 and a security policy 440. Traffic inspection module 410, certificate capture module 420 and security policy 440 operate in the same manner as discussed above in connection with the corresponding modules of FIG. 3 and hence further description thereof will be omitted for the sake of brevity.

Certificate verification module 430 is used for sending the captured server certificate to a certificate verification service (e.g., running on a network security device, such as network security device 500 of FIG. 5 that will be described further below) and receiving a result of the verification from the certificate verification service. Certificate verification module 430 may establish a secure channel with network security device 500 if they are connected through unsafe networks, such as the Internet. Certificate verification module 430 may transmit the captured server certificate to network security device 500 through the secure channel for verification and then receive verification results. If the captured server certificate is deemed to be authentic, the verification result may be a simple confirmation message. If the captured server certificate is deemed to be a fraudulent or suspicious certificate, the verification result may indicate which portion or portions of the captured certificate are different from the authentic server certificate. The user may determine if the captured server certificate is acceptable based on the verification result.

FIG. 5 illustrates exemplary functional units of a network security device 500 in accordance with a third embodiment of the present invention. Network security device 500 is used for providing certificate verification services. In one example, network security device 500 may be a dedicated software/hardware device residing within or connected to a private network. In another example, network security device 500 may be part of a network security service provider. A non-limiting example of a network security device that may be used to provide certificate verification services to other network security devices or client devices is the FortiGuard family of network security devices available from the assignee of the present invention.

Network security device 500 includes a certificate collector 510, an authentic certificate DB 520, a network interface 530 and a certificate comparator 540. For purposes of this disclosure, it may be assumed that certificate collector 510, authentic certificate DB 520 and certificate comparator 540 operate in the same manner as the corresponding modules of FIG. 3. Therefore, further description thereof is omitted for the sake of brevity. Network interface 530 is used for communicating with other network devices, to, among other things, receive certificates from other network security devices, for example, and send verification results back to the requesting network security devices. Secure channels may be established between network security device 500 and the other network security devices in order to protect the communications against interception and/or alteration by third parties.

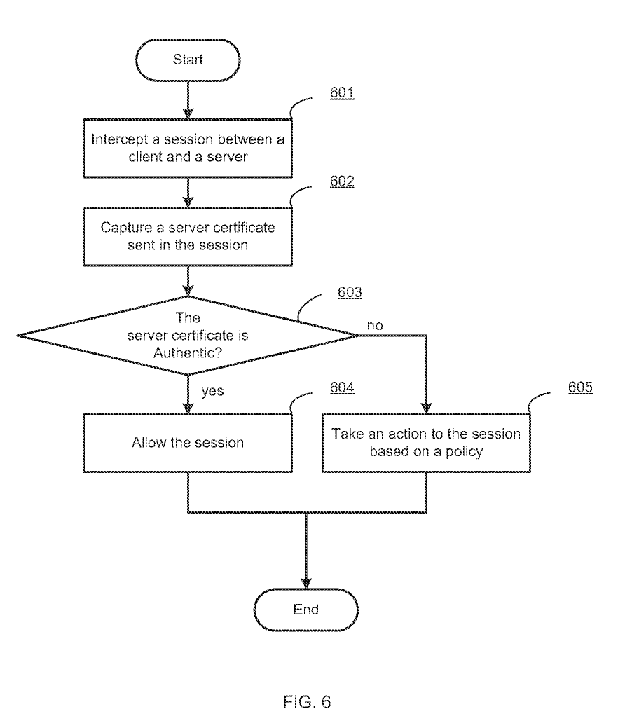

FIG. 6 is a flow diagram illustrating a method for checking a server certificate in a session between a client and a server in accordance with an embodiment of the present invention. This method may be implemented by a network security device (e.g., one representing or implementing certificate inspectors 140 and 240 and/or network security devices 300 and 400).

At block 601, a network security device intercepts a session between an SSL client and an SSL server. The network security device may be deployed at the border of a private network and may be used for controlling network traffic within the private network and/or network traffic entering or exiting the private network. The data packets going through the private network may be scanned by the network security device and session messages may be intercepted by the network security device.

At block 602, the network security device captures a server certificate that is included in a session message, e.g., a server hello message, that is used for establishing a secure channel between the SSL client and the SSL server. According to the SSL protocol, session information between the SSL client and the SSL server is negotiated through a handshake phase and the server certificate that is the identity of the SSL server is sent to the SSL client in plain text. The network security device may capture the server certificate from the session message.

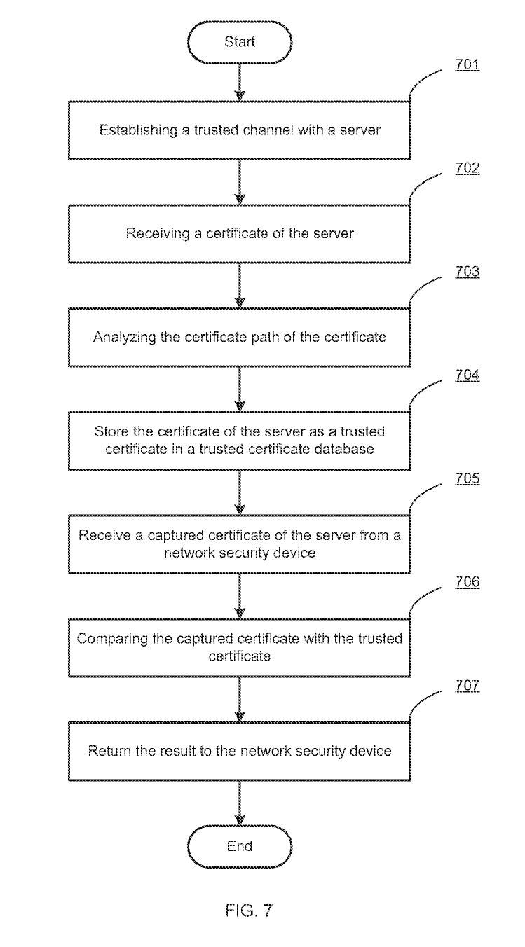

At block 603, network security device verifies the authenticity of the captured server certificate before the session is routed to the SSL client. A non-limiting example of a procedure of certificate verification is described in further detail below with reference to FIG. 7.

At block 604, the network security device may allow the session and route it to the SSL client when the captured server certificate is verified as an authentic one. Then, the SSL client and the SSL server may communicate as normal and a secure channel may be established.

At block 605, the network security device may take one or more actions with respect to the session between the SSL client and SSL server based on a security policy if the captured server certificate is deemed to be a fraudulent or suspicious certificate. For example, if the captured server certificate does not match a corresponding known authentic server certificate, then the captured server certificate may be deemed to be a fraudulent server certificate and the session between the SSL client and the SSL server may be blocked by the network security device and no secure channel may be established. In some embodiments, when the captured server certificate is deemed to be a suspicious one, a warning message may be sent to the user of the SSL client to allow the user an opportunity to determine whether the suspicious server certificate should be accepted.

FIG. 7 is a flow diagram illustrating a method for collecting and verifying server certificates in accordance with an embodiment of the present invention. This method may be implemented by a network security device (e.g., one representing or otherwise implementing certificate inspector 140 and/or certificate collector 250 or network security device 500) that provides certificate verification services.

At block 701, a network security device may establish a trusted channel with a server. Alternatively, the network security device may be deployed at a location within a network (e.g., the Internet) near the server. Because the network security device is near the server, network traffic between the network security device and the server may go through fewer intermediate network devices, thereby reducing the possibility of a third party intercepting network traffic between the network security device and server. The network security device may start an SSL session with the server and send a hello message to the server during a handshake phase. The SSL session between the network security device and the server may be deemed to be a trusted channel because the session is unlikely to be intercepted.

At block 702, the network security device may receive a server hello message returned from the server. The server certificate may be retrieved from the server hello message.

At block 703, the network security device may analyze a certificate path and other certificate information within the server certificate. For example, a trusted root certificates and any intermediate certificates may be extracted from the server certificate. The network security device may also extract other certificate information associated with the server certificate, including, but not limited to, a version, a serial number, a signature algorithm, a signature hash algorithm, a valid date, a subject, and the like.

At block 704, the network security device may store the sever certificate, certificate path and other certificate information within an authentic certificate database (e.g., authentic certificate DB 320 or 520).

In the present example, a server certificate that is received by the network security device is trusted as an authentic server certificate. It will be apparent to one skilled in the art that other mechanisms may be used for collecting authentic server certificates. For example, the most commonly used server certificate captured by multiple network security devices at different locations within a network may be deemed to be the authentic server certificate for the server at issue. The authentic server certificate may also be acquired via other online or offline channels.

At block 705, the network security device receives a captured server certificate from a requestor, e.g., certificate inspector 204 or network security device 400, for verification.

At block 706, the captured server certificate is compared with the authentic server certificate stored by the network security device. The certificate paths as well as other certificate information of the captured server certificate and the authentic server certificate may be compared to verify the authenticity of the captured server certificate. Although in the context of the present example, the authenticity of the digital certificate being verified is a server certificate, it will be apparent to one skilled in the art that the authenticity of any kind of digital certificate may be verified using the methodologies described herein.

At block 707, the result of the verification is returned to the requestor.

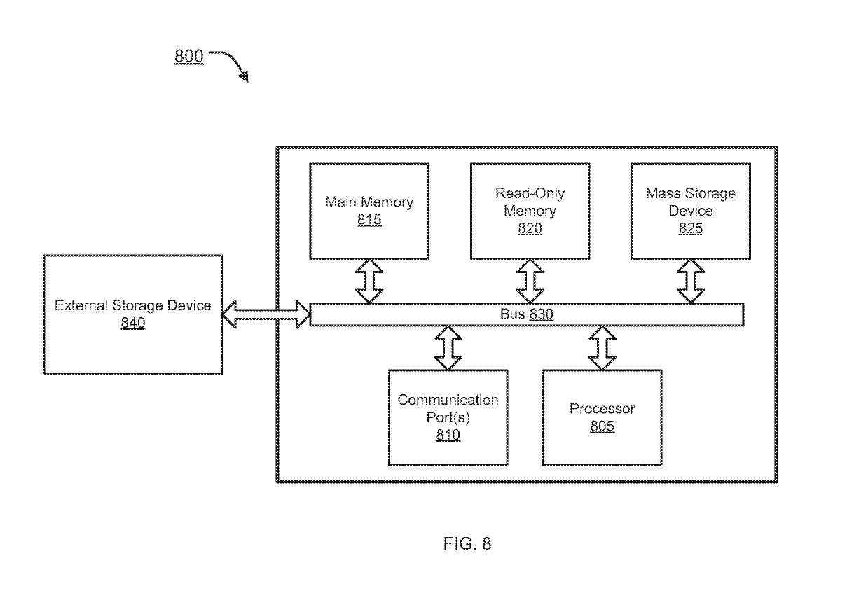

FIG. 8 is an example of a computer system 800 with which embodiments of the present disclosure may be utilized. Computer system 800 may represent or form a part of a network security device (e.g., network security device 300, 400 or 500), a server or a client workstation on which web browser 110 or 210 and/or certificate inspector 140 or 240 is running.

Embodiments of the present disclosure include various steps, which have been described in detail above. A variety of these steps may be performed by hardware components or may be embodied on a non-transitory computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 800 includes a bus 830, a processor 805, communication port 810, a main memory 815, a removable storage media 840, a read only memory 820 and a mass storage 825. A person skilled in the art will appreciate that computer system 800 may include more than one processor and communication ports.

Examples of processor 805 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 805 may include various modules associated with embodiments of the present invention.

Communication port 810 can be any of an RS-232 port for use with a modem based dialup connection, a 10/100 Ethernet port, a Gigabit or 10 Gigabit port using copper or fiber, a serial port, a parallel port, or other existing or future ports. Communication port 810 may be chosen depending on a network, such a Local Area Network (LAN), Wide Area Network (WAN), or any network to which computer system 800 connects.

Memory 815 can be Random Access Memory (RAM), or any other dynamic storage device commonly known in the art. Read only memory 820 can be any static storage device(s) such as, but not limited to, a Programmable Read Only Memory (PROM) chips for storing static information such as start-up or BIOS instructions for processor 805.

Mass storage 825 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 830 communicatively couples processor(s) 805 with the other memory, storage and communication blocks. Bus 830 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 805 to system memory.

Optionally, operator and administrative interfaces, such as a display, keyboard, and a cursor control device, may also be coupled to bus 830 to support direct operator interaction with computer system 800. Other operator and administrative interfaces can be provided through network connections connected through communication port 810.

Removable storage media 840 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
intercepting, by a network security device, a session between a client and a server, wherein a secure channel is requested to be established between the client and the server in the session;
capturing, by the network security device, a digital certificate that is being sent from the server to the client, wherein the digital certificate is used for authenticating the server in connection with establishing the secure channel;
verifying, by the network security device, whether the captured digital certificate is an authentic certificate of the server; and
performing, by the network security device, an action with respect to the session based on a result of the verifying.

2. The method of claim 1, wherein said capturing, by the network security device, a digital certificate that is being sent from the server to the client further comprises:
capturing, by the network security device, a hello message that is being sent from the server to the client during a handshake phase of the session;
intercepting, by the network security device, the digital certificate included in the hello message.

3. The method of claim 1, further comprising:
collecting, by the network security device, a trusted digital certificate of the server from a channel with the server; and
storing, by the network security device, the trusted digital certificate of the server within a storage device that is accessible to the network security device.

4. The method of claim 3, wherein the trusted digital certificate of the server is collected from a trusted channel between the network security device and the server.

5. The method of claim 3, further comprising:
collecting, by the network security device, multiple digital certificates of the server from multiple channels with the server;
comparing, by the network security device, the multiple digital certificates of the server; and
if the multiple digital certificates have matching content or matching hash values, the digital certificate is considered to be the trusted digital certificate of the server.

6. The method of claim 3, wherein the trusted digital certificate of the server is manually inputted to the network security device.

7. The method of claim 3, wherein said verifying, by the network security device, whether the captured digital certificate is an authentic certificate of the server further comprises:
comparing, by the network security device, the captured digital certificate with the trusted digital certificate of the server that has been collected by the network security device; and
confirming, by the network security device, the authenticity of the captured digital certificate when content of the captured digital certificate of the server matches corresponding content of the trusted digital certificate of the server.

8. The method of claim 7 further comprising
comparing, by the network security device, certificate paths of the captured digital certificate and the trusted digital certificate of the server; and
confirming, by the network security device, the authenticity of the captured digital certificate when the certificate paths match.

9. The method of claim 8, wherein the certificate paths comprise a trusted root certificate.

10. The method of claim 8, wherein the certificate paths comprise one or more intermediate certificates.

11. The method of claim 1, wherein said verifying, by the network security device, whether the captured digital certificate is an authentic certificate of the server further comprises:
requesting, by the network security device, verification of the captured digital certificate by a certificate collector; and
receiving, by the network security device, a result of the verification from the certificate collector.

12. The method of claim 11, further comprising:
establishing, by the network security device, a secure channel with the certificate collector; and
sending, by the network security device, the captured digital certificate to the certificate collector through the secure channel.

13. The method of claim 1, wherein the action comprises one or more of:
allowing, by the network security device, the session between the client and the server;
informing, by the network security device, the user of the client that the captured digital certificate of the server is not authentic; and
blocking, by the network security device, the session between the client and the server.
